(19) United States
(12) Patent Application Publication
(10) Pub. No.: US 2018/0054724 A1
(43) Pub. Date: Feb. 22, 2018

(54) DEVICE DISCOVERY DURING LINK AGGREGATION IN WIRELESS COMMUNICATIONS

(71) Applicant: Intel IP Corporation, Santa Clara, CA (US)

(72) Inventors: Laurent Cariou, Portland, OR (US); Yaron Alpert, Petah Tikva (IL); Bahareh Sadeghi, Portland, OR (US); Robert Stacey, Portland, OR (US)

(21) Appl. No.: 15/393,977

(22) Filed: Dec. 29, 2016

Related U.S. Application Data
(60) Provisional application No. 62/377,310, filed on Aug. 19, 2016.

(51) Int. Cl. H04W 8/00; H04W 76/02

(52) U.S. Cl. CPC H04W 8/005; H04W 76/025

(57) ABSTRACT

This disclosure describes systems, methods, and devices related to link aggregation between devices. A device may identify multi-band capabilities associated with a first device. The device may determine the frequency band of the first device based at least in part on the multi-band capabilities. The device may initiate multi-band link aggregation on one or more interfaces, wherein a first interface of the one or more interfaces is associated with the first device. The device may cause to establish a connection with a second device using a second interface of the one or more interfaces.

### CROSS-REFERENCE TO RELATED APPLICATIONS

This application claims the benefit of U.S. Provisional Application 62/377,310, filed on Aug. 19, 2016, the disclosure of which is incorporated herein by reference as if set forth in full.

### TECHNICAL FIELD

This disclosure generally relates to systems, methods, and devices for wireless communications and, more particularly, enhancing the performance of wireless devices by using link aggregation between these wireless devices.

### BACKGROUND

Efficient use of the resources of a wireless local area network (WLAN) is important to provide bandwidth and acceptable response times to the users of the WLAN. However, often there are many devices trying to share the same resources, and some devices may be limited by the communication protocol they use or by their hardware bandwidth.

### BRIEF DESCRIPTION OF THE DRAWINGS

The present disclosure is illustrated by way of example and is not limited by the accompanying drawings, in which like references indicate similar elements and in which:

FIG. 1 illustrates a wireless local area network (WLAN), in accordance with one or more example embodiments of the present disclosure.

FIG. 2 illustrates load balancing on two air interfaces, in accordance with one or more example embodiments of the present disclosure.

FIG. 3A illustrates a deployment scenario of a link aggregation system, in accordance with one or more example embodiments of the present disclosure.

FIG. 3B illustrates various states for a link aggregation system, in accordance with one or more example embodiments of the present disclosure.

FIG. 4 illustrates a frame structure format, in accordance with one or more example embodiments of the present disclosure.

FIG. 5A depicts a flow diagram of an illustrative process for an illustrative link aggregation system, in accordance with one or more example embodiments of the present disclosure.

FIG. 5B depicts a flow diagram of an illustrative process for an illustrative link aggregation system, in accordance with one or more example embodiments of the present disclosure.

FIG. 6 illustrates a functional diagram of an example communication station that may be suitable for use as a user device, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Example embodiments described herein provide certain systems, methods, and devices for enhancing the performance of wireless devices using link aggregation between multiple access points in various wireless networks, including, but not limited to, IEEE 802.11ax, IEEE 802.11ay, IEEE 802.11ah or wireless based on 5G 3GPP technologies.

In the past two decades, the IEEE 802.11 WLAN networks have experienced tremendous growth with the proliferation of Wi-Fi devices used as a major Internet access scheme for mobile computing and electronic devices. Since the early deployment of IEEE 802.11 devices in both enterprise and public networks, there have only been proprietary solutions to provide coordination among access points (APs). However, such coordination is transparent to client devices, meaning that a client device, also called a station (STA), establishes a physical layer connection with only one AP at a time. That is, the STA is able to communicate with only one AP at a time for a particular communication session.

In one embodiment, a link aggregation system may provide link aggregation of data planes between different wireless air interfaces on different frequency bands (800 MHz, 2.4 GHz, 5 GHz, 60 GHz, and others).

In one embodiment, a link aggregation system may enable the discovery of an optimal small coverage AP (e.g., 60 GHz, Bluetooth, Zigbee, etc.) by an STA already associated with a large coverage AP. Consequently, the STA may connect to the optimal small coverage AP and establish continuous connectivity service, for example, based on multi-band link aggregation functionality.

In some embodiments, a link aggregation system may define several elements including, for example, sets of frames that may be used to share multi-band (800 MHz, 2.4 GHz, 5 GHz, 60 GHz, and others) and link aggregation capabilities (e.g., load-balancing, splitting, and merging of data packets),) or in the same frequency band within different channels, and to enable setting up a link aggregation system by negotiating the different parameters (frequency bands, streams, policies, etc.).

In one embodiment, a link aggregation system may facilitate the splitting of data packets received into two streams of data packets. The two streams may be associated with two interfaces, such that each interface is associated with a specific frequency band. It should be noted that one interface may collect and/or accumulate two MAC entities that may be associated with a specific frequency band. This may be referred to as having L2 streams.

In one embodiment, a link aggregation system may facilitate load-balancing of the two L2 data streams such that packets are evenly distributed between the two interfaces or between the two L2 data streams on one interface or may be one interface is favored over another interface based on traffic and network conditions. It may be also possible to customize the load-balancing of the two L2 data streams based on preferences.

In one embodiment, a link aggregation system may receive an individual packet at a destination device from one or more streams from each interface from a source device.

In some embodiments, a link aggregation system may provide two modes of operation: a centralized mode and a distributed mode. In a centralized mode of operation, in some embodiments, an STA may first connect to a large coverage AP (LC-AP) before connecting or establishing communication with a small coverage AP (SC-AP). The link aggregation system may initiate a multi-band setup protocol in some embodiments, and within that protocol, the LC-AP may coordinate the selection and resource allocations of the best SC-AP. In such a mode and in some embodiments, the LC-AP may govern the setup of link aggregation. In the distributed mode, the multi-band link aggregated setup protocol may be initiated from an STA on either the LC-AP or the SC-AP. In some embodiments, the STA may connect first to the LC-AP or to the SC-AP.

In one embodiment, a link aggregation system may determine whether an STA first connects to an LC-AP. In that case, the procedure may be similar to a centralized mode, where for example, a multi-band link aggregation setup protocol may be initiated by either the LC-AP or the STA on an LC-AP band. The LC-AP may provide information to help the STA select the best SC-AP on its own and, in some embodiments, connect to it. Once connected, the multi-band link aggregation setup may be completed in accordance with various embodiments.

In another embodiment, a link aggregation system may determine whether the STA first connects to an SC-AP. In that case, the SC-AP may provide information about the relevant LC-AP in the area. At this point, there may be, in some embodiments, two STA behavior options: the STA may initiate multi-band aggregated service via the SC-AP (option A), or the STA can in some embodiments switch to the LC-AP (option B) and then initiate multi-band aggregation.

Embodiments described herein may improve multi-band operation by improving the selection of an optimal AP candidate, which may provide one or more improvements, such as improvements in the latency to establish link aggregation, reduction in the overhead of scanning frames and pre-association frames, and improvements in the quality of link aggregation, for example, by triggering link aggregation setup when selective conditions are met.

The above descriptions are for purposes of illustration and are not meant to be limiting. Numerous other examples, configurations, processes, etc., may exist, some of which are described in detail below. Example embodiments will now be described with reference to the accompanying figures.

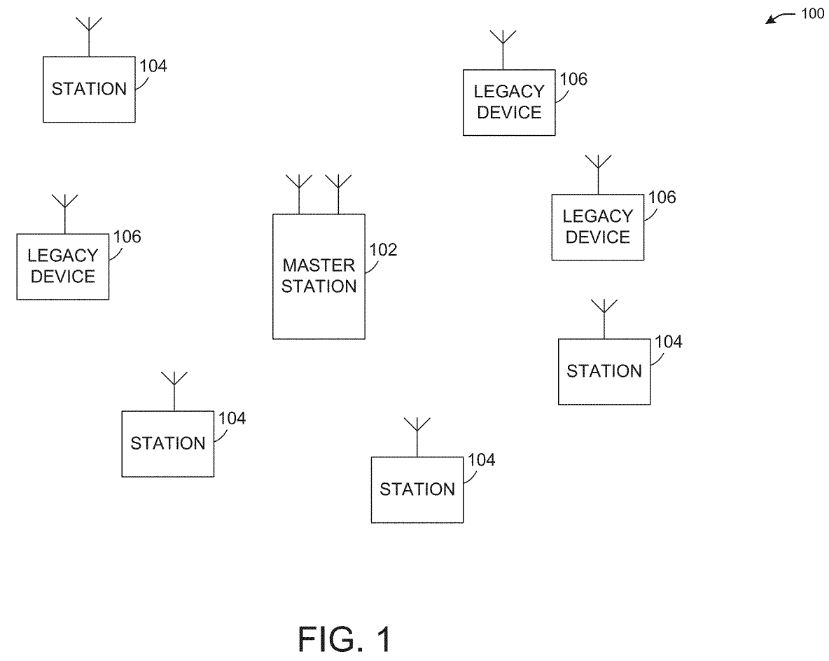

FIG. 1 illustrates a wireless local area network (WLAN) 100 in accordance with some embodiments. The WLAN may comprise a basis service set (BSS) or personal BSS (PBSS) that may include a master station 102, which may be an AP or PBSS control point (PCP), a plurality of wireless STAs 104, and a plurality of legacy (e.g., IEEE 802.11n/ac/ad) stations 106. It should be understood that the terms master station 102 and AP 102 are used interchangeably in this disclosure for ease of use.

The master station 102 may be an AP using the IEEE 802.11 protocol to transmit and receive packets. The master station 102 may be a base station. The master station 102 may be a PBSS. The master station 102 may use other communications protocols as well as the IEEE 802.11 protocol. The IEEE 802.11 protocol may be IEEE 802.11ay. The IEEE 802.11 protocol may include using orthogonal frequency division multiple access (OFDMA), time division multiple access (TDMA), and/or code division multiple access (CDMA) or combination. The IEEE 802.11 protocol may include a multiple access technique. For example, the IEEE 802.11 protocol may include space-division multiple access (SDMA), multiple-input multiple-output (MIMO), multi-user MIMO (MU-MIMO), and/or single-input single-output (SISO). The master station 102 and/or wireless STA 104 may be configured to operate in accordance with NG60, WiGiG, and/or IEEE 802.11ay.

The legacy stations 106 may operate in accordance with one or more of IEEE 802.11 a/b/g/n/ac/ad/af/ah/aj, or another legacy wireless communication standard. The legacy stations 106 may be STAs or IEEE STAs. The wireless STAs 104 may be wireless transmit and receive devices such as cellular telephones, smart telephones, handheld wireless devices, wireless glasses, wireless watches, wireless personal devices, tablets, or other devices that may be transmitting and receiving using the IEEE 802.11 protocol such as IEEE 802.11ay or another wireless protocol. In some embodiments, the wireless STAs 104 may operate in accordance with IEEE 802.11ax. The wireless STAs 104 and/or the master station 102 may be attached to a BSS.

The master station 102 may communicate with the legacy stations 106 in accordance with legacy IEEE 802.11 communication techniques. In example embodiments, the master station 102 may also be configured to communicate with wireless STAs 104 in accordance with legacy IEEE 802.11 communication techniques. The master station 102 may use the techniques of IEEE 802.11ad for communication with legacy devices. The master station 102 may be a personal basic service set (PBSS) Control Point (PCP), which can be equipped with a large aperture antenna array or modular antenna array (MAA).

The master station 102 may be equipped with more than one antenna. Each of the antennas of the master station 102 may be a phased array antenna with many elements. In some embodiments, an IEEE 802.11ay frame may be configurable to have the same bandwidth as a channel. The frame may be configured to operate over one to four 2160 MHz channels. The channels may be contiguous.

An IEEE 802.11ay frame may be configured for transmitting a number of spatial streams, which may be in accordance with MU-MIMO. In other embodiments, the master station 102, the wireless STA 104, and/or the legacy station 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile Communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to IEEE 802.11ay communications. In accordance with some IEEE 802.11ay embodiments, a master station 102 may operate as a master station which may be arranged to contend for a wireless medium (e.g., during a contention period) to receive exclusive control of the medium for performing enhanced beamforming training for a multiple access technique such as OFDMA or MU-MIMO. In some embodiments, the multiple-access technique used during the TxOP (transmit opportunity) may be a scheduled OFDMA technique, although this is not a requirement. In some embodiments, the multiple-access technique may be a space-division multiple access (SDMA) technique.

The master station 102 may also communicate with legacy stations 106 and/or wireless STAs 104 in accordance with legacy IEEE 802.11 communication techniques.

The wireless STAs 104, the master station 102, and/or the legacy stations 106 may be any addressable unit. It should be noted that any addressable unit might be an STA) An STA may take on multiple distinct characteristics, each of which shape its function. For example, a single addressable unit might simultaneously be a portable STA, a quality-of-service (QoS) STA, a dependent STA, and a hidden STA. The wireless STAs 104, the master station 102, and/or the legacy stations 106 may be STAs. The wireless STAs 104, the master station 102, and/or the legacy stations 106 may operate as a personal basic service set (PBSS) control point/access point (PCP/AP). The wireless STAs 104, the master station 102, and/or the legacy stations 106 may include any suitable processor-driven device including, but not limited to, a mobile device or a non-mobile, e.g., a static, device. For example, the wireless STAs 104, the master station 102, and/or the legacy stations 106 may include a user equipment (UE), an STA, an AP, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc., may also be included in this list.

Any of the wireless STAs 104, the master station 102, and/or the legacy stations 106 may be configured to communicate with each other via one or more communications networks wirelessly or wired. The wireless STAs 104 and/or the legacy stations 106 may also communicate peer-to-peer or directly with each other with or without the master station 102. Any of the communications networks may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the wireless STAs 104, the master station 102, and/or the legacy stations 106 may include one or more communications antennas. The one or more communications antennas may be any suitable type of antennas corresponding to the communications protocols used by the wireless STAs 104, the master station 102, and/or the legacy stations 106. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the wireless STAs 104, the master station 102, and/or the legacy stations 106.

MIMO beamforming in a wireless network may be accomplished using RF beamforming and/or digital beamforming. In some embodiments, in performing a given MIMO transmission, the wireless STAs 104, the master station 102, and/or the legacy stations 106 may be configured to use all or a subset of its one or more communications antennas to perform MIMO beamforming.

Any of the wireless STAs 104, the master station 102, and/or the legacy stations 106 may include any suitable radio and/or transceiver for transmitting and/or receiving radio frequency (RF) signals in the bandwidth and/or channels corresponding to the communications protocols utilized by any of the wireless STAs 104, the master station 102, and/or the legacy stations 106 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 800 MHz channels (e.g. 802.11ah), via 2.4 GHz channels (e.g., 802.11b, 802.11g, 802.11n, 802.11ax), 5 GHz channels (e.g., 802.11n, 802.11ac, 802.11ax), or 60 GHz channels (e.g., 802.11ad). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

In example embodiments, the wireless STA 104 and/or the master station 102 are configured to perform the methods and operations herein described in conjunction with FIGS. 1, 2, 3A, 3B, 4, 5A, and 5B.

Embodiments described herein provide improvements regarding next generation Wi-Fi or for 802.11ax that can involve definition of a link aggregation of data planes between different Wi-Fi air interfaces on different frequency bands (e.g., 800 MHz, 2.4 GHz, 5 GHz, 60 GHz, and others) in accordance with the embodiments described herein and/or same frequency band and/or combination. For example, simultaneous dual band operation (2.4 GHz and 5 GHz) can be present in some APs on the market today, and tri-band devices may become available in the market soon. Link aggregation can also be an improvement to embodiments involving multiple air interfaces in the same band (for example, two independent IEEE 802.11ac/ax air interfaces at 5 GHz on two different 80 MHz channels).

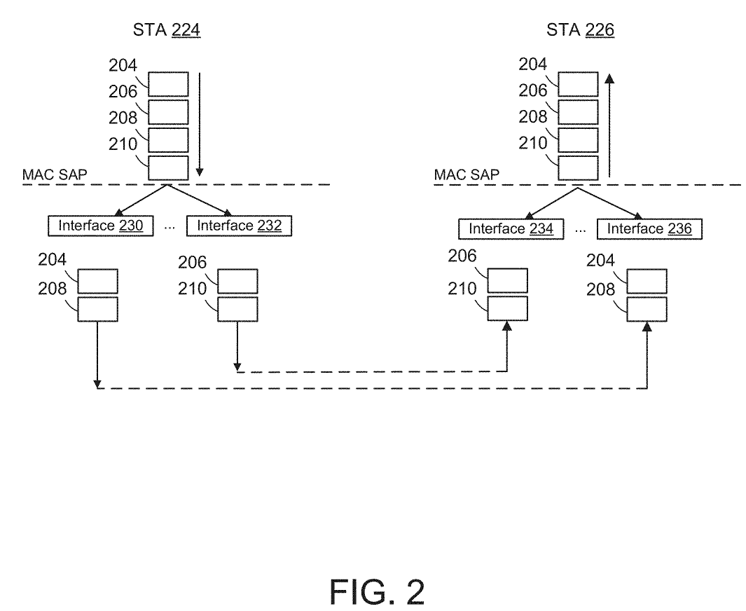

FIG. 2 depicts an illustrative schematic diagram of load balancing on two air interfaces, in accordance with one or more example embodiments of the present disclosure.

Referring to FIG. 2, there is shown two devices (e.g., STA 224 and STA 226). The STA 224 may be a device that is transmitting data to the STA 226. In this example, the STA 224 may process packets 204, 206, 208, and 210 that may be arriving from higher layers (e.g., above the MAC layer) that are destined to the STA 226.

In one embodiment, a link aggregation system may facilitate load-balancing by splitting of data packets received into one or more streams of data packets. The one or more streams may be associated with one or more interfaces, such that each interface is associated with a specific frequency band. For example, one interface may be associated with a 5 GHz frequency band, and another interface may be associated with a 60 GHz frequency band, or both interfaces may be associated with the same frequency band. It should be understood that although a 5 GHz frequency band and a 60 GHz frequency band is listed above, any other type of interface may be employed.

In one embodiment, and referring to the example of FIG. 2, a load-balancing of the one or more streams may be implemented by the link aggregation system such that the packets are evenly distributed between the one or more interfaces or may be one interface is favored over another interface based on traffic and network conditions. It may be also possible to customize the load-balancing of the one or more streams based on preferences associated with a particular standard, a system administrator, a network administrator, a user preference, or any other customization.

The STA 224 may split the streams of packets 204, 206, 208, and 210 between two interfaces, interface 230 and interface 232, into two streams. For example, interface 230 may send packets 204 and 208 to STA 226, and interface 232 may send packets 206 and 210 to STA 226. Similarly, on the STA 226, there may be two interfaces, interface 234 and interface 236 that may receive the two streams coming from the STA 224. For example, interface 234 may receive packets 206 and 210, and interface 236 may receive packets 204 and 208. The packets 204, 206, 208, and 210 may be merged from the different interfaces and reordered. The packets may then be delivered in the original order to the higher layers.

It should be noted that the lower MAC and PHY on each of the links can in some embodiments operate independently of each other. Balancing the flow only on one of the two or more links is an example embodiment of such a use case. It is understood that the above descriptions are for purposes of illustration and are not meant to be limiting.

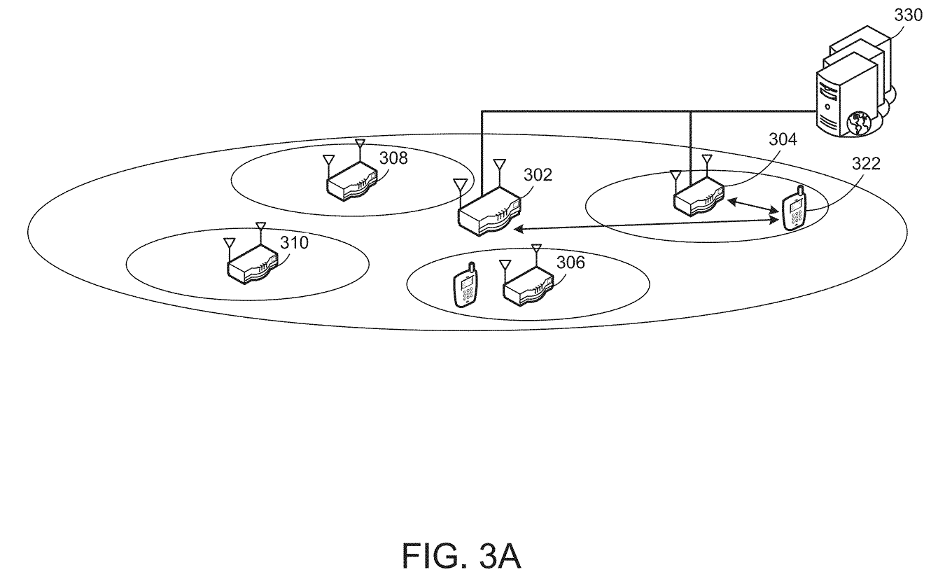

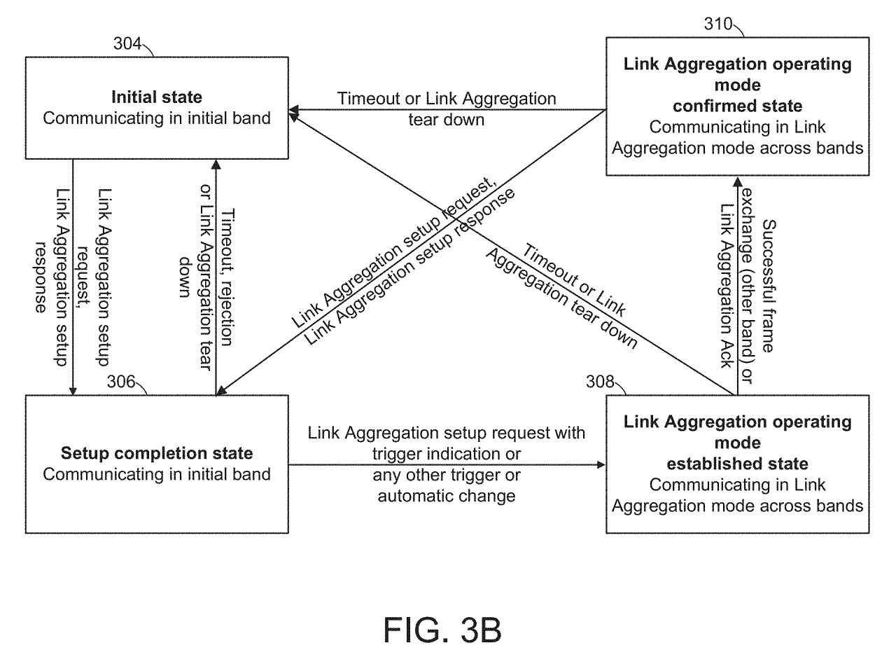

FIG. 3A depicts an illustrative schematic diagram of a link aggregation system, in accordance with one or more example embodiments of the present disclosure.

Referring to FIG. 3A, there is shown a deployment scenario with large coverage APs (LC-APs), non-collocated small coverage APs (SC-APs), and a controller 330. In this example, one LC-AP (e.g., AP 302) and multiple SC-APs, which include AP 304, AP 306, AP 308, and AP 310, are shown. The LC-AP may operate, for example, at 2.4 GHz or 5 GHz frequencies, while the SC-APs may operate, for example, at 60 GHz, Bluetooth, ZigBee, or other high-frequency bands. The SC-APs may be deployed within the coverage of the LC-AP.

In one embodiment, a link aggregation system may facilitate communications between a user device 322 and multiple APs (e.g., LC-APs and/or SC-APs). For example, the user device 322 may be able to communicate with the AP 302 and the AP 304 in one communication session. That is, when the user device 322 is acting as a source STA such that it is transmitting frames to another device (e.g., AP 302 and/or AP 304), the user device 322 may be configured to split its outgoing packets across multiple interfaces, where each interface is associated with a particular frequency band. For example, in a two interface scenario, where one interface is associated with a 5 GHz frequency band and other interface is associated with a 60 GHz frequency band, the user device 322 may be configured to split its packets arriving from a higher layer across the two interfaces before transmitting frames over the air to two devices (e.g., AP 302 and AP 304, on the respective interface). Further, the user device 322 may be able to receive multiple streams from multiple devices and may be configured to aggregate the frames received on the respective interfaces. For example, the user device 322 may receive two streams, one from AP 302, and another one from AP 304. The user device 322 may merge the packets from different interfaces and reorder them before delivering them in the original order to the higher layers.

The AP 302 and the AP 304 are shown to be connected to a controller 330. The controller 330 may be considered as an entity that manages multiple APs having multiple coverages. The controller 330 may control APs that may be either co-located or not co-located. Further, the controller 330 may control APs configured for different frequency bands. The controller 330 may be configured to receive data traffic and may distribute the received data traffic to the respective AP. It is understood that the above descriptions are for purposes of illustration and are not meant to be limiting.

FIG. 3B depicts an illustrative schematic diagram of a link aggregation system, in accordance with one or more example embodiments of the present disclosure.

Referring to FIG. 3B, there is shown a number of states that may be facilitated by a link aggregation system in order to enhance the performance of wireless devices using link aggregation between multiple devices.

In one embodiment, a link aggregation system may define four states: (1) a first state (e.g., state 304), which is the initial state. State 304 may be applicable when link aggregation (LA) is not established yet; (2) a second state (e.g., state 306), which is the setup completion state, where the LA has been set up; (3) a third state (e.g., state 308), which is the LA operating mode established state, where the LA is implemented on the data plane; and (4) a fourth state (e.g., state 310), which is the LA operating mode confirmed state, when the LA is implemented on the data plane, and a successful exchange confirmed that all is working well.

In one embodiment, a link aggregation system may transition from one state to another as follows. For example, in the transition from state 304 to state 306, the link aggregation system may establish an LA session in the initial state and transfer it to the setup completion state, an initiator device (e.g., an STA and/or an AP, or any addressable device), and a responder device (e.g., an STA, an AP, or any addressable device) shall exchange the LA setup request and the LA setup response frames. There might be multiple LA setup request and LA setup response frame transmissions by the initiator device and the responder device, respectively, until the fast session transfer (FST) between these devices becomes established. For this, the responder device may use the “status code field” in the LA setup frame, which can be set to “success” if it accepts the LA setup request, to “rejected_with_suggested_changes” to propose some other changes, or to “request_declined” to reject an LA setup request frame. It should be noted that an LA session may exist in the setup completion state, the LA operating mode established state, and the LA operating mode confirmed state. The transition from state 306 to state 308 may be automatic either instantaneously or after a pre-agreed duration of time, or can be triggered by a specific trigger frame (like the LA setup frame with a specific trigger information) or can be triggered by a specific timeout, or by a specific event. The transition from state 308 to state 310 may be done when a successful frame exchange has been done on all of the bands that are different from the one used in the initial state. The transition from state 304 to state 306 is when a change must be done in the LA, such as a change of policy for a stream, a power save on one channel band, and/or a change of the band/channel/AP. The transition can be done by a frame exchange of the LA setup frame, or any other trigger (possibly shorter feedbacks if the changes are small).

In one embodiment, a link aggregation system may enable the discovery of an optimal (e.g., the “best”) small coverage AP by an STA already associated with a large coverage AP. Consequently, the STA may connect to the optimal small coverage AP and establish continuous connectivity service, for example, based on multi-band link aggregation functionality.

In one embodiment, the embodiments described herein provide solutions, for example, for LC-APs having at least one large coverage radius AP and multiple SC-APs, where the SC-APs each have a small coverage radius within the coverage of an LC-AP.

The embodiments described provide solutions for STAs to select, to connect, and to get service for an optimal (e.g., the “best”) SC-AP (and/or LC-AP) combinations using the multi-band link aggregation setup protocol. Embodiments described herein also enable multi-band service continuity using, for example, a common multi-band link aggregation between a single LC-AP that is connected to several SC-APs. Solutions are defined herein for embodiments to select the best SC-AP for link aggregation at the beginning of the multi-band link aggregation setup protocol.

In some embodiments, a link aggregation system may provide two modes of operation: a centralized mode and a distributed mode. In a centralized mode of operation, in some embodiments, the STA may first connect to an LC-AP (e.g., the AP 302 of FIG. 3A) before connecting or establishing communication with an SC-AP. Referring back to FIG. 3A, the link aggregation system may initiate a multi-band setup protocol in some embodiments, and within that protocol the LC-AP (e.g., the AP 302) may coordinate the SC-AP selection and resource allocations of the best SC-AP (e.g., APs 304, 306, 308, or 310). In such a mode and in some embodiments the LC-AP may govern the setup of link aggregation. In the distributed mode, the multi-band link aggregated setup protocol can in some embodiments be initiated from the user device 322 of FIG. 3A on either the SC-AP (e.g., the AP 302) or the LC-AP (e.g., the APs 304, 306, 308, or 310). In some embodiments, the user device 322 may connect to the LC-AP first or to the SC-AP, for example as illustrated below.

(1) If a user device 322 first connects to the LC-AP (e.g., the AP 302), the procedure may, in some embodiments, be similar to the centralized mode, where for example, a multi-band link aggregation setup protocol may be initiated by either the AP 302 or the user device 322 on the LC-AP band. The AP 302 may in some embodiments provide information to help the user device 322 select the best SC-AP (e.g., the APs 304, 306, 308, or 310) on its own, and in some embodiments connect to it. Once connected, the multi-band link aggregation setup may be completed in accordance with various embodiments.

(2) If the user device 322 first connects to the SC-AP (e.g., the APs 304, 306, 308, or 310), the SC-AP may in some embodiments provide information about the relevant LC-AP (e.g., the AP 302) in the area. At this point, there may be, in some embodiments, two user device behavior options: the user device (e.g., the user device 322) may initiate multi-band aggregated service via the SC-AP (option A), or the user device can in some embodiments switch to the LC-AP (option B) and then initiate multi-band aggregation.

Although the examples above describe scenarios with large coverage APs and small coverage APs, embodiments described herein can also be applied to any types of deployment scenarios, such as equal coverage APs. In addition, although examples described herein can include a multi-band link aggregation setup protocol, embodiments described herein can also be applied to fast session transfer protocols.

Embodiments described herein can improve multi-band operation, for example as described in some of the foregoing scenarios, by improving the selection of the optimal candidate AP. For example, embodiments can provide one or more improvements. These improvements may include improvements in the latency to establish link aggregation, reduction in the overhead of scanning frames and pre-association frames, and improvements in the quality of link aggregation, for example, by triggering link aggregation setup only when selective conditions are met. Other improvements may include (1) throughput optimizations by reducing overhead, such that data may be aggregated and sent in a more efficient way; (2) latency optimizations by reducing the system delays, such that a packet may be sent in the next TXOP regardless of the band; (3) reduce system load, by reducing the collision ratio since less PPDU is sent over the air; (4) improve context switching between bands; (5) power optimization due to less power for transmission of data; and (6) making multi-band operation transparent to the upper layer.

In one embodiment, a link aggregation system may facilitate a centralized mode operation between multiple devices (e.g., an STA, an LC-AP, and SC-AP, or any addressable device). The centralized mode operation may include operations where an STA connects to the LC-AP, and the STA and the LC-AP may exchange multi-band capabilities using, for example, an extended multi-band element. For example, the LC-AP may indicate that it is multi-band capable and link aggregation capable. The LC-AP may also provide a modified neighbor report that includes information about the SC-APs that can be eligible for multi-band link aggregation. This report may also include the basic service set ID (BSSID), the channel used and the frequency band of operation, possibly the target beacon transmission time, and other indications. The neighbor report may also include information indicating that the APs can be used for link aggregation. In some embodiments, the neighbor report elements can be included directly in the new multi-band element. In some embodiments, the STA may also indicate that it is a multi-band capable device and that it is available on the SC-APs' frequency band in accordance with some embodiments.

In one embodiment, along with the neighbor report for the SC-APs, the LC-AP may include guidance for the STA to connect to one of the candidate SC-APs in accordance with various embodiments. For example, the LC-AP may request an immediate report from the STA on the candidate neighbor's SC-APs (e.g., received signal strength indicator (RSSI) measured before beamforming training on beacons, RSSI measured after beamforming training, estimated MCS, estimated throughput, etc.). In some embodiments, the AP may also request that the STA provide such reports regularly every few seconds. In order to save overhead and reduce latency, for each SC-AP, in some embodiments, the LC-AP may provide a specific target time at which the SC-AP may be available for the required measurements (e.g., to perform beamforming training). Further, the LC-AP may also request no immediate report from the STA, but in some embodiments, request that the STA provides a report once a specific condition has been met. For example, such a condition can be that the RSSI/MCS/throughput from a candidate SC-AP listed in the neighbor report is above a specific threshold indicated in the request. In another example, a condition may be time intervals at which the measurements should be done in accordance with various embodiments. Based on the information provided, the STA may regularly scan for the candidate SC-APs and compare the measurements with the provided threshold. If the condition for reporting is met, the STA may send a report to the LC-AP indicating the ID of the candidate SC-AP that may meet the conditions. When the conditions for establishing multi-band link aggregation are met, the LC-AP may initiate link aggregation setup on two bands, or in some embodiments via Fast Session Transfer (FST) with a planned fallback on the LC-AP's frequency band.

In one embodiment, a link aggregation system may facilitate a distributed mode operation between multiple devices (e.g., an STA, an LC-AP, and SC-AP, or any addressable device). The distributed mode operation may include operations where a link aggregation system may determine if the STA first connects to the LC-AP. In that case, the LC-AP may provide information to help the STA select the best SC-AP on its own, and in some embodiments connect to it. If connected, a multi-band link aggregation setup can be initiated by either the LC-AP or the STA in accordance with various embodiments. Alternatively, in some embodiments, the multi-band link aggregation setup protocol can be initiated before searching for SC-APs, and it can in some embodiments be completed once the STA connects to a selected SC-AP.

In some embodiments, if the STA first connects to the SC-AP, the SC-AP may provide information about the LC-AP that is in the area. In some embodiments, the STA may connect to this LC-AP on its own. Once connected, a multi-band link aggregation setup may be initiated by either the LC-AP or the STA. Alternatively, in some embodiments the multi-band link aggregation setup protocol may be initiated before searching for the LC-APs, and in some embodiments it can be completed once the STA connects to the LC-AP.

The information that is provided can in some embodiments be in the form of a modified neighbor report, which in some embodiments can include the BSSID, the band and channel of operation, the target time for beacon transmissions, and other desired information. In addition, the information can include a defined (measurement) threshold, where such a defined threshold is obtained before a connection can be made, or before link aggregation is initiated.

In one embodiment, and referring to FIG. 3B, a link aggregation system may determine the selection of the optimal SC-AP based at least in part on multiple options. For example, a first option may include that the optimal SC-AP selection may be done in state 304, for example, either before or during negotiation of the link aggregation parameters, which may be done with the exchange of multi-band link aggregation setup requests and response frames. If the optimal SC-AP selection is done before negotiation of such parameters, the multi-band link aggregation setup requests and response frames may define the SC-AP that can be used for link aggregation. In a second option, the SC-AP selection can be done in state 306. In such embodiments, the negotiation for link aggregation may be done without having selected a specific SC-AP. In addition, the STA and the LC-AP may stay in state 306 until an SC-AP has been selected. In such embodiments, the SC-AP selection may be the trigger to move to state 308. It is understood that the above descriptions are for purposes of illustration and are not meant to be limiting.

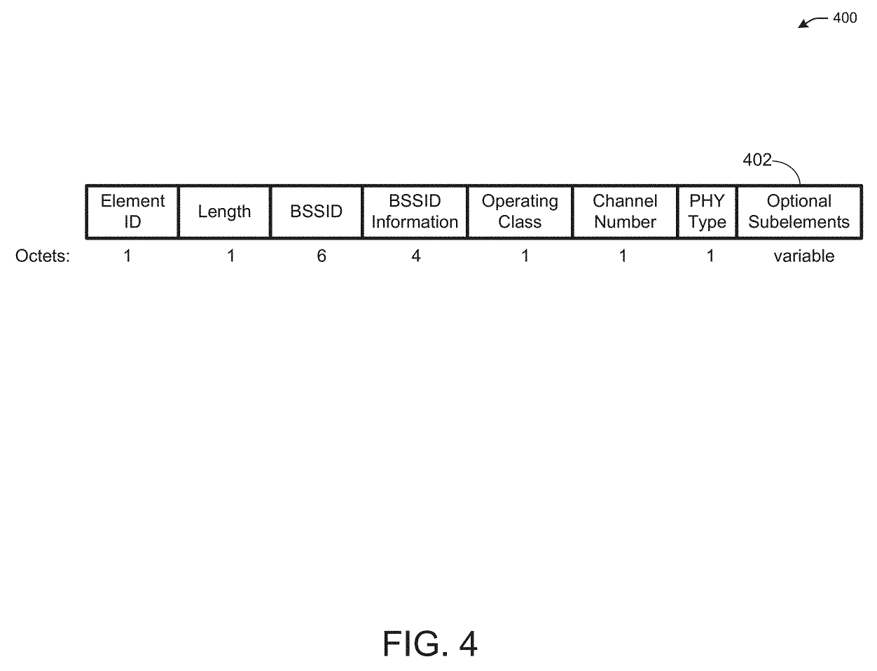

FIG. 4 depicts an illustrative frame structure 400 associated with a link aggregation system, in accordance with one or more example embodiments of the present disclosure.

Referring to FIG. 4, a neighbor band report element may be used. In order to exchange link aggregation messaging in accordance with, in some embodiments, the states of FIG. 3B, a neighbor band report element may include a frame structure having one or more fields. The fields may include an element ID field, a length field, a BSSID field, a BSSID information field, an operating class field, a channel number field, a PHY type field, and an optional subelements field 402.

In one embodiment, a link aggregation system may utilize the optional subelements field 402 during the various embodiments of the link aggregation system. The optional subelements field 402 may contain one or more subelement IDs. Examples of the optional subelement IDs for a neighbor report are illustrated in Table 1 below.

TABLE 1

| Subelement ID | Name | Extensible |
|---|---|---|
| 0 | Reserved | |
| 1 | TSF Information | Yes |
| 2 | Condensed Country String | Yes |
| 3 | BSS Transition Candidate Preference | |
| 4 | BSS Termination Duration | |
| 5 | Bearing | |
| 6 (#5184) | Wide Bandwidth Channel | Yes (#5860) |
| 7-38 | Reserved | |
| 39 (#2403) | Measurement Report | Subelements |
| 40-44 | Reserved | |
| 45 | HT Capabilities Subelement | Yes |
| 46-60 | Reserved | |
| 61 | HT Operation Subelement | Yes |
| 62 | Secondary Channel Offset Subelement | |
| 63-65 | Reserved | |
| 66 | Measurement Pilot Transmission | Subelements |
| 67-69 | Reserved | |
| 70 | RM Enabled Capabilities | Yes |
| 71 | Multiple BSSIDs | Subelements |
| 72-190 (11ac) | Reserved | |
| 191 (11ac) | VHT Capabilities | Yes |
| 192 (11ac) | VHT Operation | Yes |
| 193-220 | Reserved | |
| 221 | Vendor Specific | |
| 222-255 | Reserved | |

In some embodiments, a reserved subfield ID (e.g., 222-255) for an optional subelement may be used to define new subfields associated with the operations of the link aggregation system. For example, a “link aggregation candidate preference” subfield may be defined, which may include a preference field for each candidate AP, for example, in case the AP has some preference in terms of performance or aggregation complexity. A “link aggregation trigger conditions” subfield may be defined, which may include the set of conditions to trigger link aggregation with an AP, or to trigger measurement feedbacks. This subfield may include the type of measurement used (e.g., RSSI, MCS, throughput, etc., if not defined in the specification), and the threshold to reach to trigger link aggregation (e.g., RSSI threshold, MCS threshold, throughput threshold, etc.) in accordance with various embodiments of the link aggregation system.

In some embodiments, instead of utilizing the neighbor report element, a new element may be defined for link aggregation conditions that incorporates the same information described in the previous paragraph. In some embodiments, this element may be included in the multi-band element, along with multiple neighbor reports. This element may also be included in the multi-band link aggregation setup frames or FST setup frames, for example, along with multiple neighbor reports. In some embodiments, this element may also be included in beacons, along with the neighbor reports, in order to clarify that the neighbor reports are transmitted for link aggregation purposes.

In a centralized mode, the STA may need to provide the information to the LC-AP about the candidate SC-AP on which the trigger conditions are met. A link aggregation measurement report frame may be defined, which may include the BSSID of the selected candidate SC-AP, where for example, the BSSID information may be sufficient for the LC-AP that receives this frame to identify the selected candidate SC-AP. The link aggregation measurement report may also include the type of measurement used, and the measurement based on a threshold, for example, the RSSI threshold, the MCS threshold, the throughput threshold, etc.

It should be noted that only the BSSID may be needed in some embodiments, and that the other information may be optional in some embodiments. For example, the AP may still know that the measurement done on such AP may be over the threshold that it requested to meet. Further, there may be multiple BSSIDs that are fed back, for example, if multiple BSSIDs meet the conditions set by the AP.

In some embodiments, in a decentralized mode, after having checked that a candidate AP meets the requirements, the STA may send a link aggregation setup frame on the LC-AP or the SC-AP to end the link aggregation setup process. Such a link aggregation setup frame can include the BSSID of the SC-AP to which it wants to connect. It is understood that the above descriptions are for purposes of illustration and are not meant to be limiting.

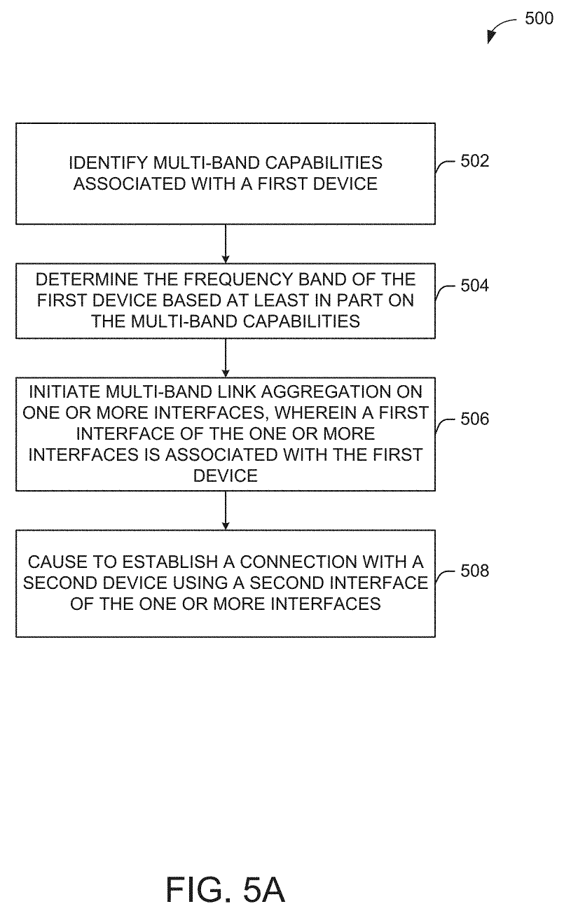

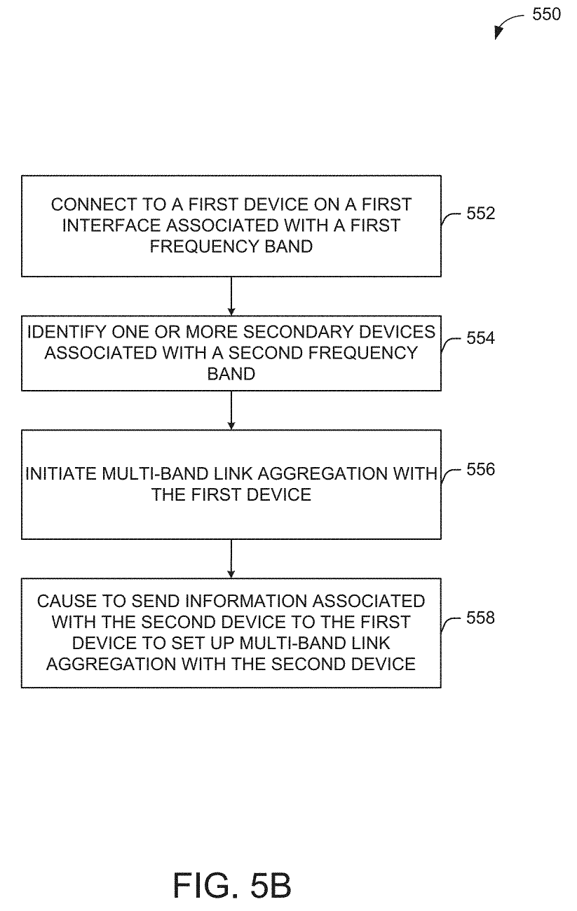

FIG. 5A illustrates a flow diagram of an illustrative process 500 for an illustrative link aggregation system, in accordance with one or more example embodiments of the present disclosure.

At block 502, a device (e.g., the STA 104 of FIG. 1) may identify multi-band capabilities associated with a first device (e.g., the master station or AP 102 of FIG. 1). For example, the STA 104 and the AP may exchange multi-band capabilities using, for example, an extended multi-band element. For example, the AP may indicate that it is multi-band capable and link aggregation capable. The AP may also provide a modified neighbor report that includes information about the SC-APs that can be eligible for multi-band link aggregation. For example, the STA 104 may receive a frame from an AP, where the frame may include a neighbor report element. The neighbor report element may include a frame structure having one or more fields. The fields may include an element ID field, a length field, a BSSID field, a BSSID information field, an operating class field, a channel number field, a PHY type field, and an optional subelements field. The STA 104 may utilize the optional subelements field in order to determine information associated with the discovery of additional APs. For example, the optional subelement may be used to define new subfields associated with the operations of the link aggregation system. For example, a “link aggregation candidate preference” subfield may be defined, which may include a preference field for each candidate AP, for example, in case the AP has some preference in terms of performance or aggregation complexity. A “link aggregation trigger conditions” subfield may be defined, which may include the set of conditions to trigger link aggregation with an AP, or to trigger measurement feedbacks. This subfield may include the type of measurement used (e.g., RSSI, MCS, throughput, etc., if not defined in the specification), and the threshold to reach to trigger link aggregation (e.g., the RSSI threshold, the MCS threshold, the throughput threshold, etc.) in accordance with various embodiments of the link aggregation system.

At block 504, the STA 104 may determine the frequency band of the AP based at least in part on the multi-band capabilities.

At block 506, the STA 104 may initiate multi-band link aggregation on one or more interfaces. For example, if two interfaces are used, a first interface may be associated with one frequency band and a second interface may be associated with another (or may be the same) frequency band. For example, using a large coverage AP (LC-AP) and a small coverage AP (SC-AP), if the STA 104 first connects to the LC-AP, a multi-band link aggregation setup protocol can be initiated by either the LC-AP or the STA 104 on the LC-AP frequency band. The LC-AP may provide simple information to help the STA 104 select the best secondary AP, which may be an SC-AP on its own and then the STA 104 may connect to this SC-AP. Once connected, the multi-band link aggregation system may be implemented between the STA 104 and the LC-AP and the SC-AP using the one or more states defined in FIG. 3B. If the STA 104 first connects to the SC-AP, the SC-AP may have information about the relevant LC-AP that is in proximity of the STA 104. At this point, the STA 104 may initiate the multi-band aggregated service via the SC-AP (option A), or may switch to the LC-AP (option B) and then initiate multi-band aggregation.

At block 508, the STA 104 may cause to establish a connection with a second device using a second interface of the one or more interfaces. Once connected, the multi-band link aggregation system may be implemented between the STA 104 and the LC-AP and the SC-AP using the one or more states defined in FIG. 3B. It is understood that the above descriptions are for purposes of illustration and are not meant to be limiting.

FIG. 5B illustrates a flow diagram of an illustrative process 550 for an illustrative link aggregation system, in accordance with one or more example embodiments of the present disclosure.

At block 552, a device (e.g., the AP 102 of FIG. 1) may connect to an STA 104 of FIG. 1 on a first interface associated with a first frequency band. The first frequency band may be associated with the AP 102. For example, the frequency band may be 2.4 GHz, 5 GHz, 60 GHz, etc.

At block 554, the AP 102 may identify one or more second devices associated with a second frequency band. For example, the AP 102 may identify a secondary AP that may be a good candidate to establish a connection with the STA 104. The LC-AP may coordinate the SC-AP selection and resource allocations of the optimal SC-AP. For example, if the AP 102 is an LC-AP (e.g., 2.4 GHz or 5 GHz), the AP 102 may identify an SC-AP (e.g. 60 GHz) that may be a good candidate to be involved in a multi-band link aggregation in order to serve the STA 104.

At block 556, the AP 102 may initiate multi-band link aggregation with the AP 102. In this case, the STA 104 may need to identify information associated with the SC-AP in order to establish a connection with the SC-AP.

At block 558, the AP 102 may send information associated with the SC-AP to the STA 104 to set up multi-band link aggregation with the SC-AP. The information may include identification information of the second device. For example, the AP 102 may send a modified neighbor report that includes information about the SC-APs that can be eligible for multi-band link aggregation. This report may also include the basic service set ID (BSSID), the channel used and the frequency band of operation, possibly the target beacon transmission time, and other indications. The neighbor report may also include information indicating that the APs can be used for link aggregation. The neighbor report elements may be included directly in the new multi-band element. The STA 104 may also indicate that it is a multi-band capable device and that it is available on the SC-APs' frequency band in accordance with some embodiments.

Along with the neighbor report for the SC-APs, the AP 102 may include guidance for the STA 104 to connect to one of the candidate SC-APs in accordance with various embodiments. For example, the AP 102 may request an immediate report from the STA on the candidate neighbor SC-APs (e.g., received signal strength indicator (RSSI) measured before beamforming training on beacons, RSSI measured after beamforming training, estimated MCS, estimated throughput, etc.). The AP 102 may also request that the STA 104 provide such report regularly every few seconds. In order to save overhead and reduce latency, for each SC-AP, the AP 102 may provide a specific target time at which the SC-AP may be available for the required measurements (e.g., to perform beamforming training). Further, the AP 102 may also request no immediate report from the STA 104, but in some embodiments, request that the STA 104 provide a report once a specific condition has been met. For example, such a condition can be that the RSSI/MCS/throughput from a candidate SC-AP listed in the neighbor report is above a specific threshold indicated in the request, and the time intervals at which the measurements should be done in accordance with various embodiments. Based on the information provided, the STA 104 may regularly scan for the candidate SC-APs and compare the measurements with the provided threshold. If the condition for reporting is met, the STA 104 may send a report to the AP 102 indicating the ID of the candidate SC-AP that may meet the conditions. When the conditions for establishing multi-band link aggregation are met, the AP 102 may initiate link aggregation setup on two bands, or in some embodiments via a fast session transfer (FST) with a planned fallback on the AP 102's frequency band.

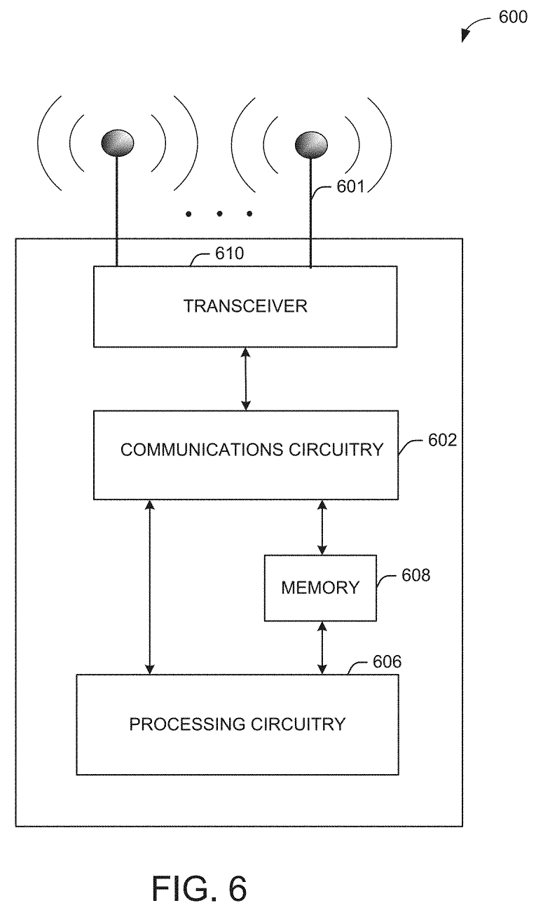

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a station 104 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or media access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 2, 3A, 3B, 4, 5A and 5B.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

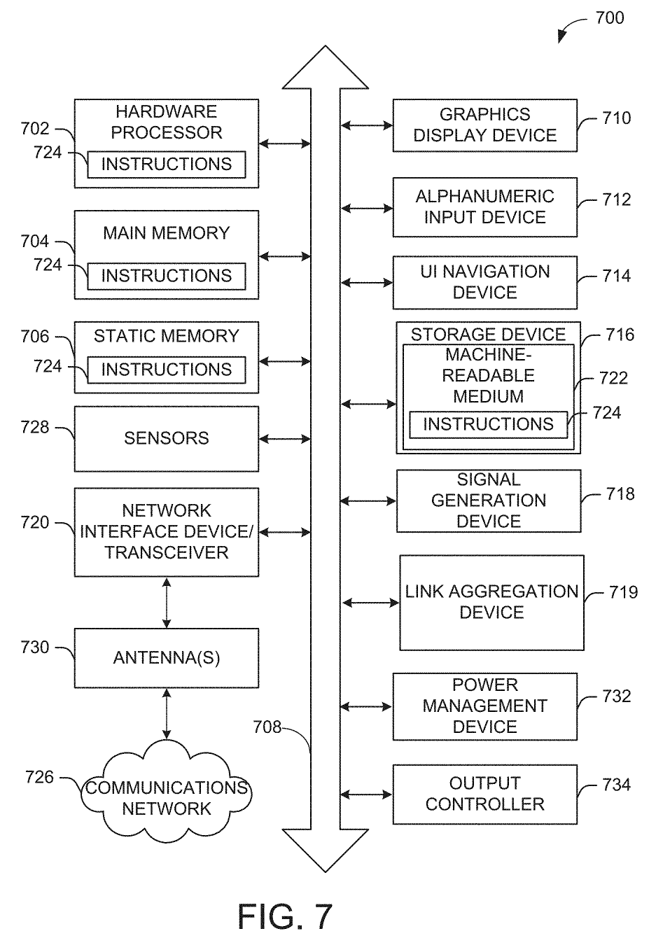

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a link aggregation device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The link aggregation device 719 may carry out or perform any of the operations and processes (e.g., the processes 500 and 550) described and shown above. For example, the link aggregation device 719 may provide link aggregation of data planes between different wireless air interfaces on different frequency bands (2.4 GHz, 5 GHz, 60 GHz, and others).

The link aggregation device 719 may define several elements, including for example, sets of frames that may be used to share multi-band (2.4 GHz, 5 GHz, 60 GHz, and others) and link aggregation capabilities (e.g., load-balancing, splitting, and merging of data packets), and to enable setting up link aggregation system by negotiating the different parameters (frequency bands, streams, policies, etc.).

The link aggregation device 719 may enable the discovery of an optimal small coverage AP (e.g., 60 GHz, Bluetooth, Zigbee, etc.) by an STA already associated with a large coverage AP. Consequently, the STA may connect to the optimal small coverage AP and establish continuous connectivity service, for example, based on multi-band link aggregation functionality.

The link aggregation device 719 may facilitate the splitting of data packets received into two streams of data packets. The two streams may be associated with two interfaces, such that each interface is associated with a specific frequency band.

The link aggregation device 719 may facilitate load-balancing of the two streams such that packets are evenly distributed between the two interfaces or may be one interface is favored over another interface based on traffic and network conditions. It may be also possible to customize the load-balancing of the two streams based on preferences.

The link aggregation device 719 may receive individual packets at a destination device from one or more streams from each interface from a source device.

The link aggregation device 719 may provide two modes of operation: a centralized mode and a distributed mode. In a centralized mode of operation, in some embodiments, an STA may first connect to an LC-AP before connecting or establishing communication with an SC-AP. The link aggregation device 719 may initiate a multi-band setup protocol in some embodiments, and within that protocol, the LC-AP may coordinate the SC-AP selection and resource allocations of the best SC-AP. In such a mode and in some embodiments the LC-AP may govern the setup of link aggregation. In the distributed mode, the multi-band link aggregated setup protocol can be initiated from an STA on either the SC-AP or the LC-AP. In some embodiments, the STA may connect to the LC-AP first or to the SC-AP.

The link aggregation device 719 may determine whether an STA first connects to an LC-AP. In that case, the procedure may be similar to a centralized mode, where for example, a multi-band link aggregation setup protocol may be initiated by either the LC-AP or the STA on an LC-AP band. The LC-AP may provide information to help the STA select the best SC-AP on its own, and in some embodiments connect to it. Once connected, the multi-band link aggregation setup may be completed in accordance with various embodiments.

The link aggregation device 719 may determine whether the STA first connects to an SC-AP. In that case, the SC-AP may provide information about the relevant LC-AP in the area. At this point, there may be, in some embodiments, two STA behavior options: the STA may initiate multi-band aggregated service via the SC-AP (option A), or the STA can in some embodiments switch to the LC-AP (option B) and then initiate multi-band aggregation.

Embodiments described herein may improve multi-band operation, by improving the selection of an optimal candidate AP, which may provide one or more improvements, such as improvements in the latency to establish link aggregation, reduction in the overhead of scanning frames and pre-association frames, and improvements in the quality of link aggregation, for example, by triggering link aggregation setup when selective conditions are met.

It is understood that the above are only a subset of what the link aggregation device 719 may be configured to perform and that other functions included throughout this disclosure may also be performed by the link aggregation device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a single input single output (SISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include memory and processing circuitry configured to identify multi-band capabilities associated with a first device. The memory and processing circuitry may be further configured to determine a first frequency band of the first device based at least in part on the multi-band capabilities. The memory and processing circuitry may be further configured to initiate multi-band link aggregation on one or more interfaces, wherein a first interface of the one or more interfaces is associated with the first frequency band of the first device. The memory and processing circuitry may be further configured to cause to establish a connection with a second device using a second interface of the one or more interfaces.

The implementations may include one or more of the following features. The memory and the processing circuitry may be further configured to determine a second frequency band of the second device. The first interface and the second interface are associated with at least one of a frequency band of 800 MHz, 2.4 GHz, 5 GHz, or 60 GHz. The memory and the processing circuitry may be further configured to identify a frame, wherein the frame may include a neighbor band report element, wherein the neighbor report element comprises one or more subelements. At least one of the one or more subelements may include one or more indications to trigger link aggregation with the second device. The memory and the processing circuitry may be further configured to identify the second device based at least in part on a type of measurements included in the at least one of the one or more subelements. The memory and the processing circuitry may be further configured to determine the first device is a short coverage access point. The memory and processing circuitry may be further configured to cause to connect to the first device on the first interface. The memory and processing circuitry may be further configured to receive information from the first device. The memory and processing circuitry may be further configured to cause to connect to the second device based at least in part on the information. The memory and the processing circuitry may be further configured to determine the first device is a large coverage access point. The memory and processing circuitry may be further configured to cause to connect to the first device on the first interface. The memory and processing circuitry may be further configured to receive information from the first device. The memory and processing circuitry may be further configured to cause to connect to the second device based at least in part on the information. The device may further include a transceiver configured to transmit and receive wireless signals. The device may further include one or more antennas coupled to the transceiver.

According to example embodiments of the disclosure, there may be a device. The device may include memory and processing circuitry configured to connect to a first device on a first interface associated with a first frequency band. The memory and processing circuitry may be further configured to identify one or more second devices associated with a second frequency band. The memory and processing circuitry may be further configured to initiate multi-band link aggregation with the first device. The memory and processing circuitry may be further configured to cause to send information associated with the second device to the first device to set up multi-band link aggregation with the second device.

The implementations may include one or more of the following features. The information may include identification information of the second device. The memory and the processing circuitry may be further configured to cause to send a request for a report from the first device, wherein the report is associated with the second device. The memory and processing circuitry may be further configured to identify a response to the request, wherein the response may include at least in part measurements associated with the second device. The measurements include at least one of a received signal strength indicator (RSSI), an estimated modulation and coding scheme (MCS), or throughput. The report is requested at a predetermined interval. The report is requested when a predetermined condition associated with the request is met. The predetermined condition is when at least one of the measurements is above a predetermined threshold.

According to example embodiments of the disclosure, there may be a non-transitory computer-readable medium storing computer-executable instructions which, when executed by a processor, cause the processor to perform operations. The operations may include connecting to a first device on a first interface associated with a first frequency band. The operations may include identifying one or more second devices associated with a second frequency band. The operations may include initiating multi-band link aggregation with the first device. The operations may include causing to send information associated with the second device to the first device to set up multi-band link aggregation with the second device.

The implementations may include one or more of the following features. The information may include identification information of the second device. The operations may further include causing to send a request for a report from the first device, wherein the report is associated with the second device. The operations may include identifying a response to the request, wherein the response may include at least in part measurements associated with the second device. The measurements include at least one of a received signal strength indicator (RSSI), an estimated modulation and coding scheme (MCS), or throughput. The report is requested at a predetermined interval. The report is requested when a predetermined condition associated with the request is met. The predetermined condition is when at least one of the measurements is above a predetermined threshold.

According to example embodiments of the disclosure, there may be a non-transitory computer-readable medium storing computer-executable instructions which, when executed by a processor, cause the processor to perform operations. The operations may include determining a first frequency band of the first device based at least in part on the multi-band capabilities. The operations may include initiating multi-band link aggregation on one or more interfaces, wherein a first interface of the one or more interfaces is associated with the first frequency band of the first device. The operations may include causing to establish a connection with a second device using a second interface of the one or more interfaces.

The implementations may include one or more of the following features. The operations may further include determining a second frequency band of the second device. The first interface and the second interface are associated with at least one of a frequency band of 800 MHz, 2.4 GHz, 5 GHz, or 60 GHz. The operations may further include identifying a frame, wherein the frame may include a neighbor band report element, wherein the neighbor report element comprises one or more subelements. At least one of the one or more subelements may include one or more indications to trigger link aggregation with the second device. The operations may further include identifying the second device based at least in part on a type of measurements included in the at least one of the one or more subelements. The operations may further include determining the first device is a short coverage access point. The operations may include causing to connect to the first device on the first interface. The operations may include receiving information from the first device. The operations may include causing to connect to the second device based at least in part on the information. The operations may further include determining the first device is a large coverage access point. The operations may include causing to connect to the first device on the first interface. The operations may include receiving information from the first device. The operations may include causing to connect to the second device based at least in part on the information.

In example embodiments of the disclosure, there may be an apparatus. The apparatus may include means for identifying, by one or more processors, multi-band capabilities associated with a first device. The apparatus may include means for determining a first frequency band of the first device based at least in part on the multi-band capabilities. The apparatus may include means for initiating multi-band link aggregation on one or more interfaces, wherein a first interface of the one or more interfaces is associated with the first frequency band of the first device. The apparatus may include means for causing to establish a connection with a second device using a second interface of the one or more interfaces.

The implementations may include one or more of the following features. The apparatus may further include means for determining a second frequency band of the second device. The first interface and the second interface are associated with at least one of a frequency band of 800 MHz, 2.4 GHz, 5 GHz, or 60 GHz. The apparatus may further include means for identifying a frame, wherein the frame includes a neighbor band report element, wherein the neighbor report element comprises one or more subelements. At least one of the one or more subelements includes one or more indications to trigger link aggregation with the second device. The apparatus may further include means for identifying the second device based at least in part on a type of measurements included in the at least one of the one or more subelements. The apparatus may further include means for determining the first device is a short coverage access point. The apparatus may include means for causing to connect to the first device on the first interface. The apparatus may include means for receiving information from the first device. The apparatus may include means for causing to connect to the second device based at least in part on the information. The apparatus may further include means for determining the first device is a large coverage access point. The apparatus may include means for causing to connect to the first device on the first interface. The apparatus may include means for receiving information from the first device. The apparatus may include means for causing to connect to the second device based at least in part on the information.

In example embodiments of the disclosure, there may be an apparatus. The apparatus may include means for connecting to a first device on a first interface associated with a first frequency band. The apparatus may include means for identifying one or more second devices associated with a second frequency band. The apparatus may include means for initiating multi-band link aggregation with the first device. The apparatus may include means for causing to send information associated with the second device to the first device to set up multi-band link aggregation with the second device.

The implementations may include one or more of the following features. The information may include identification information of the second device. The apparatus may further include means for causing to send a request for a report from the first device, wherein the report is associated with the second device. The apparatus may include means for identifying a response to the request, wherein the response includes at least in part measurements associated with the second device. The measurements include at least one of a received signal strength indicator (RSSI), an estimated modulation and coding scheme (MCS), or throughput. The report is requested at a predetermined interval. The report is requested when a predetermined condition associated with the request is met. The predetermined condition is when at least one of the measurements is above a predetermined threshold.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising: memory and processing circuitry, configured to:
identify multi-band capabilities associated with a first device;
determine a first frequency band of the first device based at least in part on the multi-band capabilities;
initiate multi-band link aggregation on one or more interfaces, wherein a first interface of the one or more interfaces is associated with the first frequency band of the first device; and
cause to establish a connection with a second device using a second interface of the one or more interfaces.

2. The device of claim 1, wherein the memory and the processing circuitry are further configured to determine a second frequency band of the second device.

3. The device of claim 2, wherein the first interface and the second interface are associated with at least one of a frequency band of 800 MHz, 2.4 GHz, 5 GHz, or 60 GHz.

4. The device of claim 1, wherein the memory and the processing circuitry are further configured to identify a frame, wherein the frame includes a neighbor band report element, wherein the neighbor report element comprises one or more subelements.

5. The device of claim 4, wherein at least one of the one or more subelements includes one or more indications to trigger link aggregation with the second device.

6. The device of claim 1, wherein the memory and the processing circuitry are further configured to identify the second device based at least in part on a type of measurements included in the at least one of the one or more subelements.

7. The device of claim 1, wherein the memory and the processing circuitry are further configured to:
determine the first device is a short coverage access point;
cause to connect to the first device on the first interface;
receive information from the first device; and
cause to connect to the second device based at least in part on the information.

8. The device of claim 1, wherein the memory and the processing circuitry are further configured to:
determine the first device is a large coverage access point;
cause to connect to the first device on the first interface;
receive information from the first device; and
cause to connect to the second device based at least in part on the information

9. The device of claim 1, further comprising a transceiver configured to transmit and receive wireless signals.

10. The device of claim 9, further comprising one or more antennas coupled to the transceiver.

11. A non-transitory computer-readable medium storing computer-executable instructions which when executed by one or more processors result in performing operations comprising:
connecting to a first device on a first interface associated with a first frequency band;
identifying one or more second devices associated with a second frequency band;
initiating multi-band link aggregation with the first device; and
causing to send information associated with the second device to the first device to set up multi-band link aggregation with the second device.

12. The non-transitory computer-readable medium of claim 11, wherein the information includes identification information of the second device.

13. The non-transitory computer-readable medium of claim 11, wherein the operations further comprise:
causing to send a request for a report from the first device, wherein the report is associated with the second device; and
identifying a response to the request, wherein the response includes at least in part measurements associated with the second device.

14. The non-transitory computer-readable medium of claim 13, wherein the measurements include at least one of a received signal strength indicator (RSSI), an estimated modulation and coding scheme (MCS), or throughput.

15. The non-transitory computer-readable medium of claim 13, wherein the report is requested at a predetermined interval.

16. The non-transitory computer-readable medium of claim 13, wherein the report is requested when a predetermined condition associated with the request is met.

17. The non-transitory computer-readable medium of claim 16, wherein the predetermined condition is when at least one of the measurements is above a predetermined threshold.

18. A method comprising:
identifying, by one or more processors, multi-band capabilities associated with a first device;
determining a first frequency band of the first device based at least in part on the multi-band capabilities;
initiating multi-band link aggregation on one or more interfaces, wherein a first interface of the one or more interfaces is associated with the first frequency band of the first device; and
causing to establish a connection with a second device using a second interface of the one or more interfaces.

19. The method of claim 18, further comprising determining a second frequency band of the second device.

20. The method of claim 18, wherein the first interface and the second interface are associated with at least one of a frequency band of 800 MHz, 2.4 GHz, 5 GHz, or 60 GHz.
